(19) United States
(12) Patent Application Publication
(10) Pub. No.: US 2002/0070643 A1
(43) Pub. Date: Jun. 13, 2002

(54) Structure of lamp

(76) Inventor: Chao-Chin Yeh, Chang Hua Hsien (TW)

Correspondence Address: BROWDY AND NEIMARK, P.L.L.C., 624 NINTH STREET, NW, SUITE 300, WASHINGTON, DC, 20001-5303, US

(21) Appl. No.: 09/734,573

(22) Filed: Dec. 13, 2000

(51) Int. Cl. H01J 1/02

(52) U.S. Cl. 313/25; 313/33; 313/491

(57) ABSTRACT

A lamp is constructed to include a base adapted for connecting to an electric socket to obtain electricity, a shell fastened to the base and defining with the base an air-tight space, the shell having an inside wall coated with a layer of phosphorescent coating, an electronic ballast installed in the base and adapted to convert AC power supply into DC power supply, and at least one ultraviolet light emitting diode suspended in the air-tight space and connected to the electronic ballast and adapted to produce ultraviolet light to strike the phosphorescent coating in producing visible light upon connection of the base upon connection of the electronic ballast to power supply.

### BACKGROUND OF THE INVENTION

The present invention relates to illumination and, more specifically, to an improved structure of lamp.

Lamp bulbs and fluorescent tubes are commonly used in buildings for illumination. A regular lamp bulb comprises a base, a bulb connected to the base and defining with the base an airtight space, and a tungsten filament suspended in the airtight space. Air is drawn away from the airtight space and then filled with an inertia gas during the fabrication of the lamp bulb. Exemplars of similar lamp bulbs are seen in U.S. Pat. Nos. 6,054,812; 4,764,707. A lamp bulb of this type has numerous drawbacks. During fabrication, the vacuum status requirement of the airtight space inside the bulb is critical. No residual oxygen can be left in the airtight space. During transportation, the tungsten filament may break due to a vibration. When in use, much energy is consumed, and much heat is produced. Further, the service life of these conventional lamp bulbs is short. Conventional fluorescent tubes are commonly comprised of a tube, two electrodes arranged at two ends of the tube, and a fluorescent material coated on the inside wall of the tube. The electrodes are processed through a special treatment, and then coated with calcium carbonate or barium carbonate. The inside space of the tube is filled with an inert gas and mercury vapor. The bombardment of the mercury vapor by electrons from the electrodes provides ultraviolet light, which causes the phosphorescent material to emit visible light. U.S. Pat. No. 5,709,578 discloses a similar design. Because mercury is a toxic material, the use of mercury may cause a severe environmental problem during the fabrication or after the service life of the fluorescent tube. U.S. Pat. No. 5,128,590 discloses a compact fluorescent lamp, which comprises an electronic ballast in the base. The electronic ballast changes the voltage of input current, so as to save power supply consumption by 30% or more. However, this structure of compact fluorescent lamp does not eliminate the aforesaid environmental problem.

### SUMMARY OF THE INVENTION

The present invention has been accomplished to provide an improved structure of lamp, which eliminates the aforesaid drawbacks. It is the main object of the present invention to provide simple, low-cost, long-lasting, power-saving lamp, which produces less heat during operation. To achieve this and other objects of the present invention, a lamp is provided comprised of a base adapted for connecting to an electric socket to obtain electricity, a shell fastened to the base and defining with the base an air-tight space, the shell having an inside wall coated with a layer of phosphorescent coating, an electronic ballast installed in the base and adapted to convert AC power supply into DC power supply, and at least one ultraviolet light emitting diode suspended in the air-tight space and connected to the electronic ballast and adapted to produce ultraviolet light to strike the phosphorescent coating in producing visible light upon connection of the base upon connection of the electronic ballast to power supply.

### BRIEF DESCRIPTION OF THE DRAWINGS

FIG. 1 is a sectional view of a lamp constructed according to a first embodiment of the present invention.

FIG. 2 is a sectional view of a lamp constructed according to a second embodiment of the present invention.

FIG. 3 is a sectional view of a lamp constructed according to a third embodiment of the present invention.

### DETAILED DESCRIPTION OF THE PREFERRED EMBODIMENT

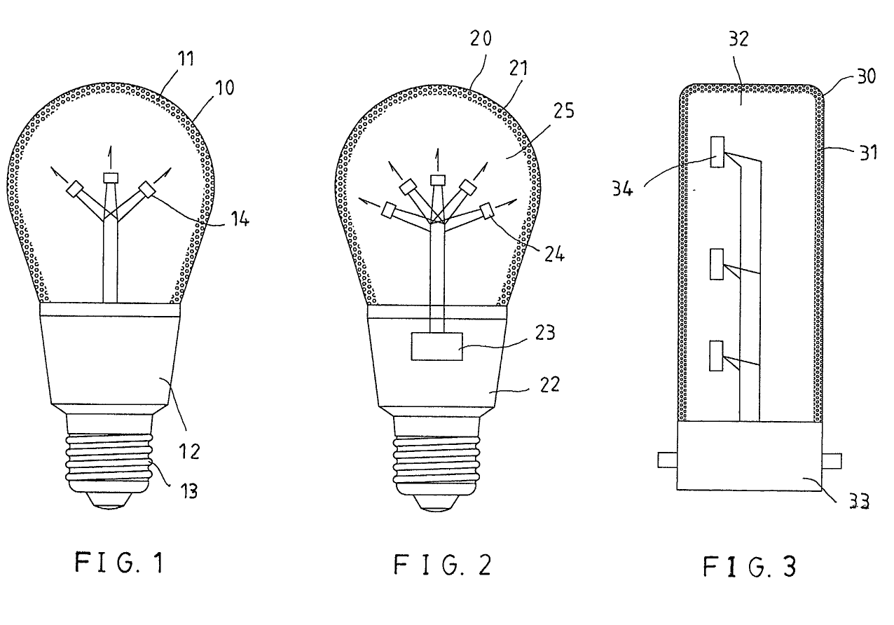

Referring to FIG. 1, a lamp in accordance with a first embodiment of the present invention is shown comprising a shell 10 that admits light. The shell 10 can be made of glass, plastics, or glass fibers. According to the present embodiment, the shell 10 is made of glass and shaped like a bulb, having a layer of phosphorescent coating 11 covered on the spherical inside wall thereof. The shell 10 has one end connected to a base 12. According to the present embodiment, the base 12 is a screw base having an outer thread 13 for threading into an electric socket to obtain electric current. The inside space of the shell 10 is sealed by the base 12. A plurality of ultraviolet LEDs (light emitting diodes) 14 are installed in inside space within the shell 10. The LEDs 14 can be connected in series or parallel. According to the present embodiment, there are three 3.6V ultraviolet LEDs 14 connected in parallel. After connection of the base 12 to an electric socket, electric current is connected to the LEDs 14, causing the LEDs 14 to emit ultraviolet light to strike the phosphorescent coating 11, and therefore the phosphorescent coating 11 is caused to emit visible light closely approximating daylight. Further, the inside space of the shell 10 can be an empty space without air in it.

FIG. 2 shows a lamp constructed according to a second embodiment of the present invention. According to this embodiment, the lamp comprises a shell 20, a layer of phosphorescent coating 11 covered on the inside wall of the shell 20, a screw base 22 connected to the shell 20 at one end, an electronic ballast 23 installed inside the screw base 22, five pieces of 3.6V ultraviolet LEDs 24 suspended in the inside space of the shell 20 and connected in parallel to the electronic ballast 23, and an inert gas, for example, nitrogen 25 filled in the inside space of the shell 20. The electronic ballast 23 converts input AC into 3.6V DC for the ultraviolet LEDs 24. The nitrogen defers the speed of oxidation of the ultraviolet LEDs 24, so as to prolong their service life.

FIG. 3 shows a lamp constructed according to a third embodiment of the present invention. According to the present embodiment, the lamp comprises a tube-like shell 30, a base 33 connected to one end of the shell 30, a layer of phosphorescent coating 31 covered on the inside wall of the shell 30, an inert gas, for example, nitrogen 32 filled in the inside space of the shell 30, and three pieces of 3.6V ultraviolet LEDs 34 suspended in the inside space of the shell 30 and connected in parallel to the base 33. According to the present embodiment, the base 33 is a bayonet base. When electrically connected, electric current is transmitted to the ultraviolet LEDs 34, causing the LEDs 34 to emit ultraviolet light that strikes the fluorescent coating 31, causing the fluorescent coating 31 to visible light closely approximating daylight.

It is to be understood that the drawings are designed for purposes of illustration only, and are not intended for use as a definition of the limits and scope of the invention disclosed.

What the invention claimed is:

1. A lamp comprising:
a base adapted for connecting to an electric socket to obtain electricity;
a shell fastened to said base and defining with said base an air-tight space, said shell comprising an inside wall coated with a layer of phosphorescent coating; and
at least one ultraviolet light emitting diode suspended in said airtight space and connected to said base and adapted to produce ultraviolet light to strike said phosphorescent coating in producing visible light upon connection of said base to an electric socket to obtain electricity.

2. The lamp of claim 1 further comprising an electronic ballast installed in said base and adapted to convert AC power supply into DC power supply for said at least one ultraviolet light emitting diode.

3. The lamp of claim 1, wherein said airtight space is a vacuum.

4. The lamp of claim 1, wherein said airtight space is filled with an inert gas.

5. The lamp of claim 4, wherein said inert gas is nitrogen.

6. The lamp of claim 1, wherein said base is a screw base.

7. The lamp of claim 1, wherein said base is a bayonet base.
